(19) United States
(12) Patent Application Publication
(10) Pub. No.: US 2006/0059535 A1
(43) Pub. Date: Mar. 16, 2006

(54) Method and apparatus for playing content

(76) Inventor: Robert F. D'Avello, Lake Zurich, IL (US)

Correspondence Address: MOTOROLA, INC., 1303 EAST ALGONQUIN ROAD, IL01/3RD, SCHAUMBURG, IL, 60196, US

(21) Appl. No.: 10/940,047

(22) Filed: Sep. 14, 2004

(51) Int. Cl. H04N 7/16

(52) U.S. Cl. 725/139

(57) ABSTRACT

A receiver such as in an automobile and/or wireless communication device is configured for a method of playing of live and recorded multimedia content. A desired genre of content is first defined. Both recorded and live content of that desired genre is identified and assembled into a playlist. Live content that is near a beginning of its being played can be rotated to a top of the playlist. In this way, live content, which a user may not have heard is given a priority of recorded content of the user. Since a start time of live content typically will not coincide with an end time of recorded content being played, the receiver can fade-in and fade-out to a the live content or buffer it for delayed play.

### FIELD OF THE INVENTION

This invention is generally directed to multimedia receiving devices, and in particular to playing multimedia content received thereon.

### BACKGROUND OF THE INVENTION

Multimedia entertainment systems commonly found in today's vehicles usually consist of an AM/FM radio, CD/DVD player and/or cassette player. The following problems are common to all such existing vehicular entertainment systems: inadequate control interface for selecting from large numbers of broadcasts and recordings, lack of multimedia playlists, and inability to manage broadcasts. These problems have been compounded with the advent of Internet radio and satellite radio services.

Radios in vehicles have historically required manual operation by a user to select a broadcast channel or a song from a cassette or CD. With the advent of satellite radio the choice of programming has become very large and has become difficult for a user to access. One solution has been the Scan function found on some radios, which will scan each radio station stopping for only a predetermined number of seconds on each one. However, the user must still interact with the Scan function to stop on any particular song. Another solution introduced to address this problem is the Radio Broadcast Data System (RBDS), also known as RDS, involving the use of FM sub-carriers. The Program Type Category (PTY) feature of an RDS radio allows searching for radio stations by their format. In this way, the satellite radio will find channels having the same genre, reducing some selection problems for the user. However, the RDS system is still not widely implemented.

Selecting content can be better facilitated with the introduction of playlists of recorded or broadcast material, such as a track listing on a CD or a downloaded broadcaster playlist, which can be presented to a user to assist selection. However, playlists are presently applied to one source at a time. In addition, switching between sources such as CD, cassette, AM broadcast, FM broadcast, Internet radio or satellite radio can still require quite of bit of user interaction, which can be distracting if the user is a driver of the vehicle. This, in addition to the vast amount of broadcast content, can become overwhelming to a user.

What is needed is a control interface to assist in presenting content from multiple sources. It would also be of benefit if the content can be presented using a multimedia playlist, which is used in conjunction with the interface to manage recordings and live broadcasts.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 shows a block diagram of a system overview, in accordance with the present invention;

FIG. 2 shows a block diagram of a vehicle multimedia receiver, in accordance with the present invention;

FIG. 3 illustrates sample menu configuration elements, in accordance with the present invention; and

FIG. 4 is a flow chart of a method in accordance with the present invention.

### DETAILED DESCRIPTION OF THE PREFERRED EMBODIMENTS

The present invention provides a control interface to assist in presenting content from multiple sources. In particular, the present invention utilizes a multimedia playlist to manage different sources. Content on the playlist is played sequentially in order or played in a randomized sequence. Special consideration is given to live broadcast material as it is undesirable to rotate the playlist to a live source while a particular item of live broadcast content is in the middle of being presented.

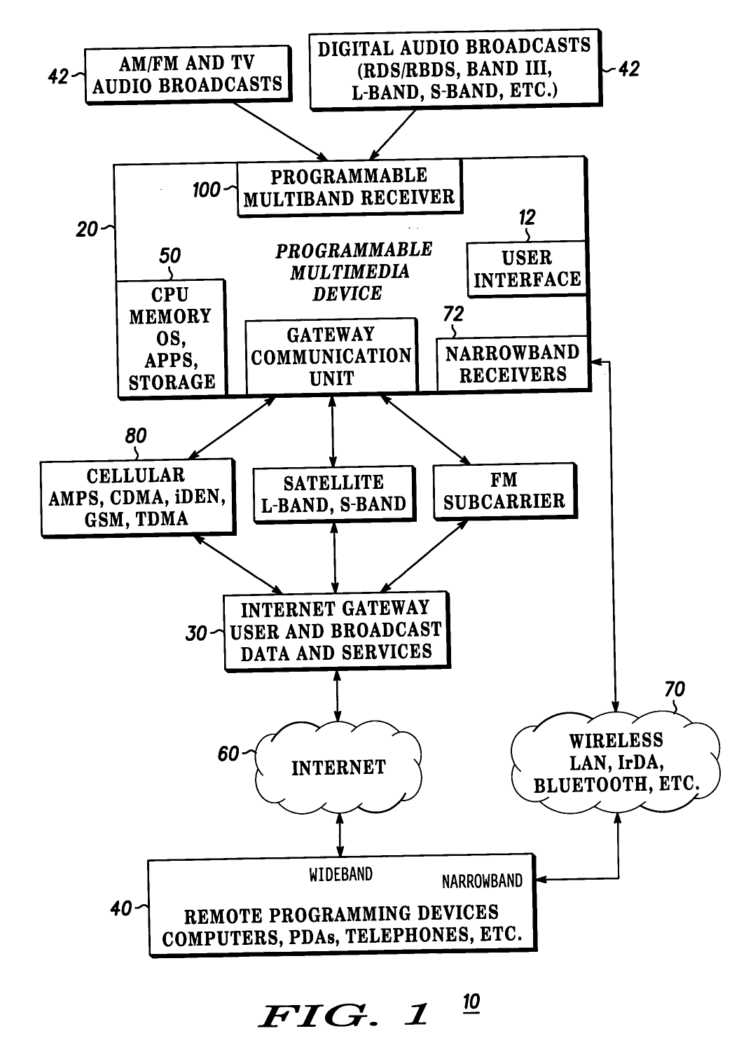

Referring to the drawings, the invention generally is a computer controlled multimedia entertainment and information system 10. The invention offers information enriched audio and/or video broadcasts from various sources including broadcast, Internet, and digital (e.g. satellite) sources, and other software expandable services in a vehicle through the use of a wireless Internet connection to an enabling Internet gateway network. As shown in FIG. 1, the invention consists of (1) a remotely programmable, microcomputer controlled multimedia device 20 in a vehicle with an optional wireless IP address for Internet access, (2) an Internet gateway network 30 that provides programming, information and Internet access to the multimedia device 20, and (3) one or more optional remote programming devices 40.

FIG. 1 shows many possible wireless communication methods between the vehicle device and the gateway. As those skilled in the art will appreciate, the methods illustrated in FIG. 1 are meant to be representative and do not reflect all possible wireless communication methods that may be employed.

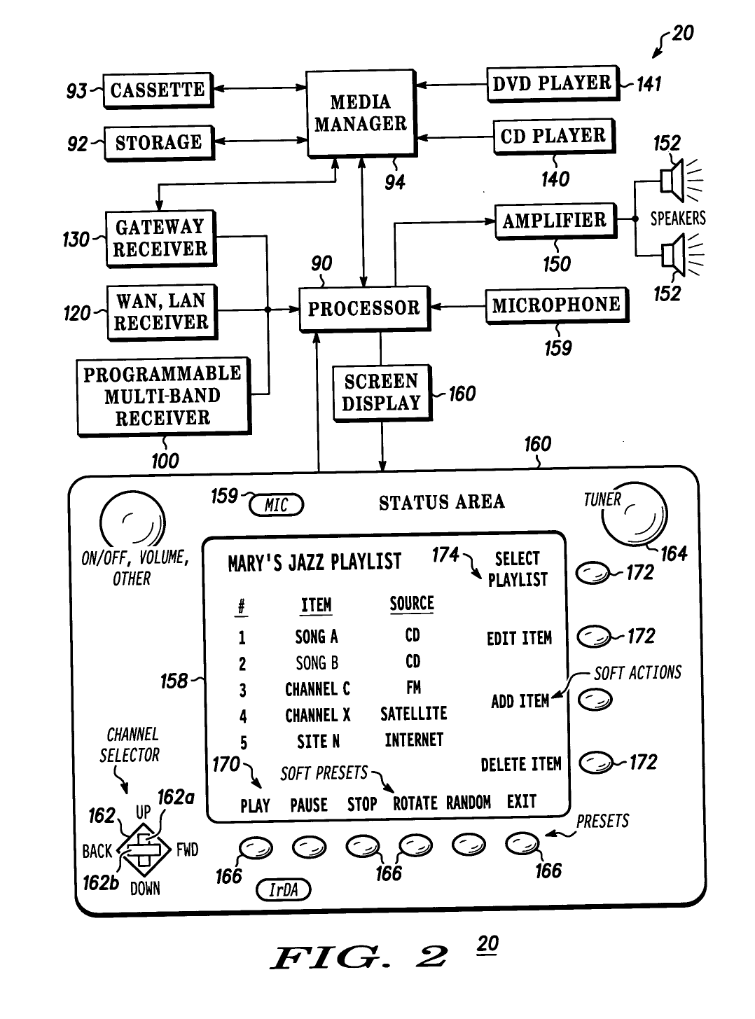

The multimedia device 20 includes a computer 50 that preferably runs an operating system and series of applications that control the operation of the device 20. A user operates an application by tuning to a “channel” in keeping with the known radio paradigm and its user friendly operations. The four types of audio channels preferably available are terrestrial broadcasts (e.g., AM, FM, TV, RDS/RBDS digital), digital satellite broadcasts (e.g. L-Band, S-Band, etc.), Internet audio broadcasts, and recorded material that is stored on local or remote media. Video channels can also be included (e.g. TV, DVD, Internet video broadcasts). Channels can be organized in a playlist on screen (see FIG. 2). Preferably, channels 42 are organized by user-desired groupings, and not by the band or frequency of the station. For example, a desired grouping can include the genre of the broadcast (i.e., country, rock, talk, etc.). In addition, a desired grouping can include the artist (e.g. The Hollies), the production studio (e.g., Disney™), the creator (e.g., PIXAR™), or other identification. The listener can configure the organization of the channels through a remote device 40 via the Internet gateway network 30.

The multimedia device 20 in the vehicle is configured to receive critical information from the broadcasters and/or the Internet gateway network 30. Information transmitted preferably includes broadcaster channel identification that allows the multimedia device 20 to tune to stations by their genre or format. For example, remote programmable devices 40, such as a computer connected to the Internet 60, are used to download information from the Internet gateway network 30 to the multimedia device 20 in the vehicle. From a remote device 40, a user can construct a playlist by preferred broadcast genre, format, artist, or title, (hereinafter collectively referred to as “genre”) along with available recorded media of the user, which is then organized in the vehicle's multimedia device 20. The user will not need to know the band or frequency of any station to select a broadcast as all types of broadcasts are simply presented by format. The multimedia device 20 will make the appropriate band and frequency selection when a listener selects a particular format category for inclusion in a playlist. Of course, it should be realized that the construction of a playlist of various sources can also be preformed directly within the vehicle, with the presence of a sufficient user interface.

In practice, a user could configure the playlist, using an Internet gateway network 30 database for example, to download information about all the formats and broadcasters (e.g., AM/FM/TV/DAB/Internet) possible for their vehicle. Optionally, notebook computers, PDAs and cellular phones could be used to wirelessly configure and download playlists into the multimedia device 20. Users would then choose to have on the playlist only those genres, formats and stations they desire, blocking out from view all unwanted genres, formats and stations. Further, users could construct different playlists for different occasions.

As noted before, the playlist preferably includes recorded material. The recorded material can include locally available media (e.g. CD, DVD, cassette), and remotely available media (e.g. previously recorded broadcasts that are recorded at a network location and then transmitted or streamed, over a wireless Internet cellular connection 80 for example, to the vehicle).

The construction of playlists allows a user to select live and recorded audio and/or video material by format in a vehicle by using a combination of a hierarchical menu along with presets for choosing a playlist on the vehicle multimedia device. Selection can be done by pressing directional and preset buttons or by using voice navigation. Optionally, unique playlists can be constructed for any number of users so that each user will see only their preferred playlist when selected at the multimedia device 20. For example, a soft control can be placed on a vehicle multimedia device listing “Mary's Jazz Playlist” which can then be selected by a key press or other user input.

These and other features and advantages of the invention will become apparent to those skilled in the art upon a review of the following detailed description of the presently preferred embodiments of the invention, when viewed in conjunction with the appended drawings.

Following is a description of the system 10 components and configuration. As shown in FIGS. 1 and 2, the multimedia device 20 consists of a computer 50 preferably having a microprocessor and memory, and storage devices 92 that contain and run an operating system and applications to control and communicate with one or more onboard receivers including: (1) a multi-band AM, FM, TV audio and digital multimedia broadcast receiver 100; (2) one or more high-speed, narrow band wireless wide-area or local-area transceivers 120 for fast transmission and reception of large amounts of data from accommodated devices; and (3) a wide band wireless Internet addressable gateway transceiver 130 to receive Internet protocol based audio broadcasts and configuration data from an Internet gateway network 30 created to service the multimedia devices 20. The multimedia device 20 also controls attached conventional multimedia storage equipment such as a CD/DVD players 140, 141 or cassette player 93. Sound is output through an industry standard amplifier 150 and speakers 152. A microphone 159 allows for voice recognition commands to be given and received by the multimedia device 20.

The multimedia device 20 preferably also contains and controls one or more digital storage devices 92 to which real-time broadcasts can be digitally recorded. The storage devices 92 may be hard drives, flash disks, or other automotive grade storage media. The same storage devices 92 can also preferably store digital data that is wirelessly transferred to the vehicle from a remote device such as an Internet gateway network 30 or user home or office network-connected device.

As FIG. 2 shows, the multimedia device also uses a LCD, LED or similar suitable display screen 160 for an automotive environment to present information to the user and to control the multimedia device 20. Controls shown on the LCD in FIG. 2 are one possible embodiment for control types and location. Those skilled in the art will appreciate that control types and locations may vary in different implementations of the invention. For example, the display can display as little as one or two lines of text, but can also have a display screen 160 as large as the intended application may dictate.

The channel selector 162, tuner 164 and preset button 166 controls shown in FIG. 2 allow the user to broadly navigate all the channels of broadcasts and subsequently constructed playlists on the multimedia device 20. The channel selector 162 allows a user to manually access and select any of the audio, video and information channels available by browsing through them (up, down, forward, back) in menus, for example. It should be understood that there are a vast number of ways that information can be presented on a display, and that the display information shown is present only by way of example, and that any possible technique for displaying and selecting information is envisioned herein.

As shown, the screen display 158 shows a final playlist screen that could be seen during operation of the present invention. The leftmost part of the screen shows the item numbers of items in the playlist (e.g. “Mary's Jazz Playlist”). The center of the screen shows the actual items in the playlist and their associated sources. For example, “Song A” and “Song B’ can be particular favorite songs on one or more CDs in the vehicle CD player 140. “Channel C” can be one or more FM channels having a particular desired genre (e.g. jazz). “Channel X” can be one or more satellite channels having a particular desired genre (e.g. jazz). “Site N” can be a website identifier that identifies an Internet site that streams a particular desired audio and/or video content (e.g. FM channel n that is outside of the vehicles normal geographical reception area). Each item can represent an individual specific item of content or can represent a family of audio having a desired format or genre. Possible types of audio formats could include rock, jazz, country, classical, talk, TV audio. Possible types of video formats could include cartoons, particular sports, weather, etc. It should be noted in this example that the items in the list include live broadcasts and recorded material. As is explained in detail below, users can configure the presentation of formats and items so that they see only those items of interest.

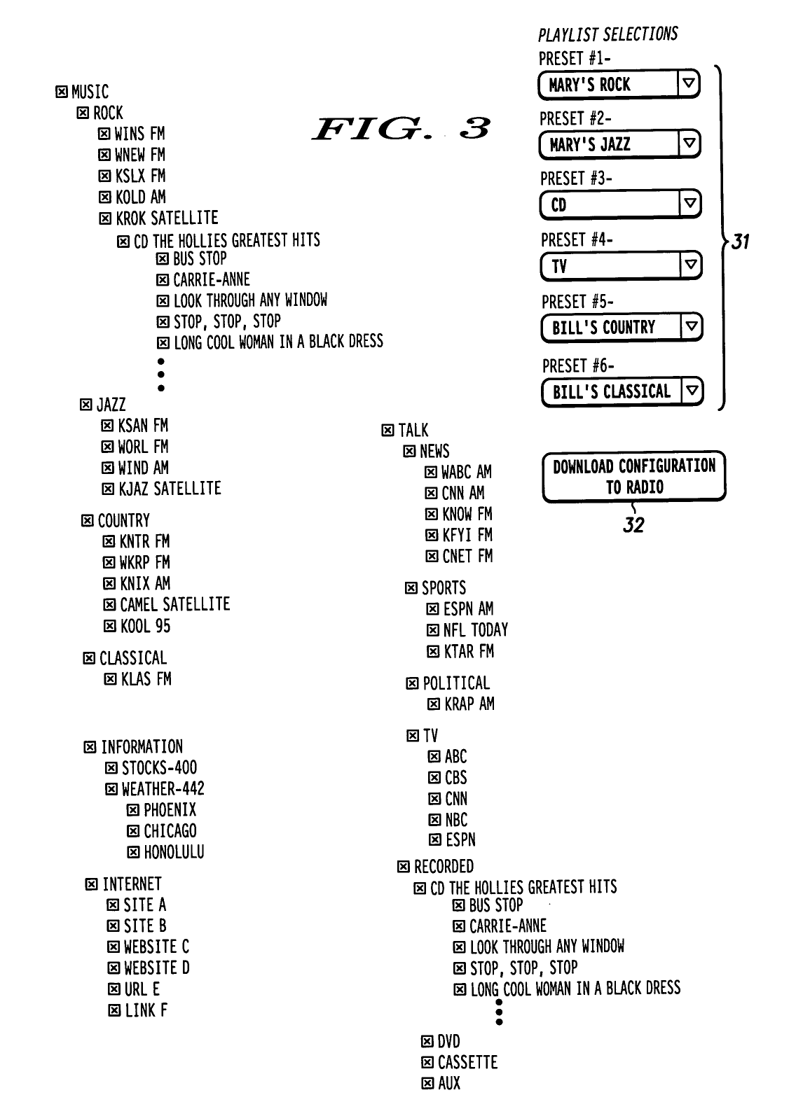

FIG. 3 shows a hierarchal menu list of example formats, channels, and playlists that could be available to a user for constructing a playlist. For example, if a user wished to construct a playlist a first menu would have the major categories of Music, Talk, Recorded, Information, and Internet shown on the display 158. Under each major category, there are subcategories as shown. The menus could be populated automatically by downloaded information from the broadcasters or Internet, or could be manually constructed by a user. For example, a user could use a computer connected to the Internet to define where the multimedia unit 20 is currently located. This information would be used to access a broadcaster database and retrieve tuning and other related information about those local stations that may be received in this area. If the user subscribes to a digital satellite broadcast service, that broadcaster's channels would also be retrieved. Internet audio or video broadcasts would also be downloaded and shown. A web page could then be dynamically created using all audio content available in the user's area organized by format. A user could also indicate available recorded material either available locally or available on the Internet (e.g. MP3 file sharing sites). Preferably, the multimedia device can automatically indicate content available on local media at the time the playlist is opened. FIG. 3 shows examples of the types of information that may be seen. By default, all formats and stations could be selected, as shown. The user will then be able to check on or off which formats and individual stations he/she prefers to see on the device 20. Any format or station that is turned off will not appear in the playlist.

For recorded media, the individual video or songs could be read from the media as a title list, for example. To see the subcategories, the user would select the desired major category by pressing the up or down channel selector buttons 162a and then press the forward button 162b when the category desired is highlighted. The user could then see all the channels available under that subcategory in similar fashion and select any of them to be stored in a playlist.

For example, under the category of music channels, commercial audio broadcasts could be subdivided into the many radio industry standard formats (e.g., blues, classical, county, dance, jazz, rock, sports, talk, etc.). To list a particular country music radio station, a user would select the “Music” category by pressing the up or down channel selector buttons 162a and then press the forward channel selector 162b when positioned on “Music.” Next, the user would use the up or down channel selector buttons 162a to highlight “Country” and would then press the forward button 162b. The user would then see all the country music channels available.

Once a user has moved forward in the hierarchical tree, the subcategory or channels displayed will remain visible until the user presses the back channel selection button 162b that moves the user back up the tree one level. For example, to move back from country broadcasts to select other music formats, the user would press the back button 162b and then select another music format. After all the channels are selected the user can select and/or define a playlist preset (such as the six presets 31 shown) to store the selected channels and recorded material in the playlist. In this example, Mary and Bill can have separate playlists and can share common playlists such as “CD” or “TV”. In a preferred embodiment, the menus and presets can be configured by a remote device using a similar display paradigm (e.g. user's computer, PDA, wireless telephone, etc. over a local wireless technology such as IrDA, IEEE 802.11 or Bluetooth) and download 32 the final playlist to the multimedia device.

Referring back to FIG. 2, preset buttons 166 on the display screen 160 are user configurable buttons that allow the user to select various actions to undertake on the playlist. For example, once a playlist is opened, a user could choose to “Play”, “Pause”, or “Stop” the audio playback as desired. Further, a user could choose to “Rotate” or “Random(ize)” or shuffle the order of the playlist. In addition, a user can use other softkeys 172 to modify the displayed playlist through editing, adding, or deleting selected items in the list, or can select another playlist to open, play, or edit. It should be recognized that many other functions can be provided on the display to operate on that or other playlists, and that these are only shown as an example. Computer programs running in the multimedia device 20 control the action of the buttons 166, 172 shown. For example, the buttons' labels 174 and purposes can change between users and between playlists. A button's label 174 indicates its current function.

Configuration data is preferably sent to the multimedia device 20 through a computer with an Internet connection using a web browser. Due to the large number of possible analog, digital and Internet based broadcasts available for reception by the multimedia receiver, choosing from the huge variety of broadcasts is less complicated if it is preprogrammed or preconfigured in advance by the user through a remote computer rather than from the multimedia device 20 itself. The user could log onto the Internet in a manner generally known in the art and then access the configuration web page via the Internet gateway network 30. Once the user has configured the web page selections as desired, he/she could submit the changes. The new configuration could then be transmitted to the multimedia device 20 in the vehicle from the Internet gateway network 30.

A microphone input 159 on the face of the display 160 allows users to control the multimedia device 20 verbally rather than through the control buttons. Key word voice recognition software allows the user to make the same channel selections that could be made from any of the button controls. Audio feedback through speech synthesis can allow a user to make selections and hear if any other actions are required. Software or hardware based voice recognition and speech synthesis, as are known in the art, can be used to implement this feature.

Referring to FIG. 2, in its most basic form, the present invention describes at least one receiver 100, 120, 130 for receiving audio content, such as a wireless communication device in a vehicle. The receiver operates in accordance with existing operational parameters. A media storage manager 94 is used to recall and/or store recorded audio content. The sources for recorded audio content can be a cassette 92, DVD player 141, CD player 140, various memory devices (hard drive, flash memory, etc.) for storage 92, and through an internet gateway 130. Preferably, the media storage manager 94 is able to retrieve a list of audio content from these devices for incorporation into a playlist, as previously described.

A user interface 12 is coupled to a controller 90 or processor of the device 20. The user interface is used for selecting, defining and playing audio content in a playlist as previously described. The playlist includes a list of a desired genre of recorded and live broadcast audio content. The controller 90 is coupled to the media storage manager 94. The controller identifies both recorded audio content of a desired genre on storage media 92, 93, 140, 141 through the media manager 94, and live audio content from the at least one receiver 100, 120, 130. The controller 90 is used to assemble the identified recorded and live audio content into a playlist for the user interface (e.g. speakers 152) to play.

A novel aspect of the present invention is having the controller determine whether an item of live content of the desired genre is near a beginning of its being played and automatically rotate that item of live content to the next item to be played from the playlist. As a user would be very familiar with their own recorded content, a user will probably wish to hear new material whenever possible and without much interruption in their enjoyment of the content. This can be accomplished by the controller, when a recorded item is being played, by scanning the live channels in the playlist for content presently being broadcast. In order to provide the rotation to live material it is necessary for the controller to know the start and end times of songs (either live or recorded) being played or at least to be able to determine or detect the start and end points.

For audio content that is already recorded it is quite easy to determine the length of the content through known means, such as an index list with track lengths. Moreover, the start and end times are controlled by the controller itself. Therefore, the status of recorded material is known to the controller. For live material, the start and end times of content can be determined in various ways. For example in satellite or Internet radio it is common for the broadcaster to send data embedded in the content that gives the start and end times of at least the song presently being played. Some broadcasters also provide a complete program guide that also specifies when particular media will be played throughout the day. The controller uses these start and stop times to determine when and how to rotate live material to the top of the user's playlist. Further, since start and stop times would rarely be aligned between the end of a recorded song and the start of a live song, the present invention provides various techniques to switch between the two.

In operation, the controller compares a start time of the next item of live audio or video content (i.e. the end time of the song presently being broadcast) from the receiver to an end time of the item presently being played by the user interface and determines whether a difference between the start time and the end time is less than a predetermined time period. The predetermined period may be a few seconds or can be adjusted by the user. An acceptable predetermined period(s) can be different depending on whether the next broadcast song is later or earlier than the end of the song presently being played from the playlist. There are three scenarios possible: a) the end of the playing song is aligned with the beginning of the next broadcast song and the controller need take no action other than rotating the live broadcast to the top of the playlist, b) the end of the playing song is earlier than the start of the next broadcast song and the controller needs to insert a blank or mute until the next broadcast song starts, and c) the end of the playing song is later than the start of the next broadcast song and the controller needs to provide a seamless transfer between the songs. In the latter case, the controller needs to eliminate any discontinuities in switching to play that live broadcast song by providing means for a more natural transition to the live song. When a live broadcast is being played, that channel should be reduced in priority when determining the next song to play, to prevent staying on that channel forever. In addition, a live broadcast channel may be playing and a live broadcast channel (another channel on the same radio or from a different source) may be the desired next channel.

There are various techniques to provide a seamless transfer that minimizes the annoyance of a user in not hearing an entire song. If the end of the playing song is later than the start of the next broadcast song (item c) above), the controller can perform one of the following options, depending on user preference (which can be included in the playlist configuration): 1) fade-out the playing song and start the broadcast song as normal at its indicated start time, 2) complete the playing song to its end time and fade-in the broadcast song, 3) fade-out the playing song before its ending time and then fade-in the broadcast song after its start time, and 4) cross-fade the songs such that the playing song fades-out before its ending time while the broadcast song fade-in after its start time.

Optionally, the controller 90 can determine whether a start time of the next item of live audio content from the receiver is earlier than an end time of the item presently being played by the user interface, whereupon controller directs the media storage manager 94 unit to buffer the next item of live audio content in storage 92 for later play by the user interface 12.

In a preferred embodiment, the controller places a priority on found items of live audio content and directs the user interface to fade the item presently being played and start play of that next item of live audio content. The present invention provides the advantage of allowing a user to listen to all or almost all of a song, without breaking into the middle of a song which can be irritating to a user.

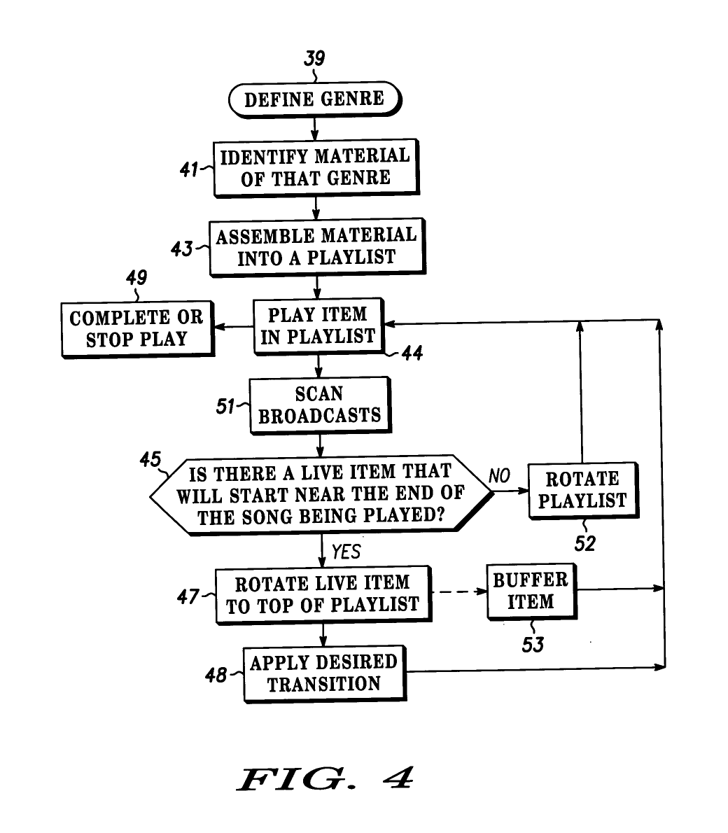

The present invention also incorporates a method of playing audio and/or video content on a wireless communication device. Referring to FIG. 4, the method includes a first step 39 of defining a desired format, genre, artist, or title (hereinafter collectively referred to as “genre”) of audio and/or video content. A playlist of recorded, and preferably live, material can then be assembled 43 by identifying 41 both recorded and live content of that desired genre. At least one of these assembled items in the playlist can be displayed on the wireless communication device. For example, the item presently playing can be displayed along with at least one other item in the playlist on the wireless communication device. Items from the playlist can then be played 44 in sequential or random (shuffled) order. While an item is being played, any live broadcast in the playlist can be scanned 51 for start and end times of content.

A next step 45 is determining whether an item of live content of the desired genre is near a beginning of its being played. This can be controlled by defining an acceptable predetermined time between an end of the presently playing song and start of the next live song not yet being broadcast and by defining the same or another acceptable predetermined time between an end of the presently playing song and start of the next live song already being broadcast. If there is no live material that's meets this criteria then the next recorded item in the playlist is rotated 52 to the top of the playlist and played 44 upon completion of playing the item from the playing step 44. However, if an item of live audio content is found in the determining step 45, this live item is rotated 47 to the next item to be played from the playlist. This can be accomplished by placing a priority on found items of live audio content, wherein if the next item to be played in the playlist has a priority, the playing step performs a fade-out of the item presently being played and starts play of that next item of live audio content. Other suitable transitions, as defined by the user and explained above, is applied 48 for the playing step 44. The playing, determining and rotating steps are repeated 48 until the playlist is completed or until stopped by a user 49. The rotating step 52 can include a sequential rotation or a random, shuffle play.

The transitions that can be applied 48 include those previously described and can include: directing the device to immediately play the next item in the playlist upon its start time, fade-out the playing song and start the broadcast song as normal at its indicated start time, complete the playing the song to its end time and fade-in the broadcast song, fade-out the playing song before its ending time and then fade-in the broadcast song after its start time, or cross-fade the songs such that the playing song fades-out before its ending time while the broadcast song fade-in after its start time.

Optionally, the determining step 45 includes determining whether a start time of the next item of live content is earlier than an end time of the item being played in the playing step, whereupon further comprising the step of buffering 53 the next item of live content.

While the present invention has been particularly shown and described with reference to particular embodiments thereof, it will be understood by those skilled in the art that various changes may be made and equivalents substituted for elements thereof without departing from the broad scope of the invention. In addition, many modifications may be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A method of playing multimedia content comprising the steps of:
defining a desired grouping of multimedia content;
identifying both recorded and live multimedia content of that desired grouping;
assembling the identified recorded multimedia content into a playlist;
playing an item from the playlist;
determining whether an item of live multimedia content of the desired grouping is near a beginning of its being played;
rotating the playlist upon completion of playing the item from the playing step, wherein if an item of live multimedia content is found in the determining step rotating the live item to the next item to be played from the playlist; and
repeating the playing, determining and rotating steps.

2. The method of claim 1, wherein the desired grouping is based on genre.

3. The method of claim 1, wherein the desired grouping is based on artist.

4. The method of claim 1, wherein the desired grouping is based on one or more of a genre, artist, production studio, and creator.

5. The method of claim 1, further comprising a step of directing the device to transition to the next item in the playlist using a user defined transition.

6. The method of claim 1, further comprising a step of displaying the item presently playing and at least one other item in the playlist on the wireless communication device.

7. The method of claim 1, wherein the determining step includes comparing a start time of the next item of live multimedia content to an end time of the item being played in the playing step and determining whether a difference between the start time and the end time is less than a predetermined time period.

8. The method of claim 1, wherein the determining step places a priority on found items of live multimedia content, wherein the playing step includes establishing if the next item to be played in the playlist has a priority wherein the playing step performs a transition between the item presently being played and the next item of live multimedia content.

9. The method of claim 1, wherein the determining step includes determining whether a start time of the next item of live multimedia content is earlier than an end time of the item being played in the playing step, whereupon further comprising the step of transitioning between the item presently being played and the next item of live multimedia content.

10. The method of claim 1, wherein the determining step includes determining whether a start time of the next item of live multimedia content is later than an end time of the item being played in the playing step, whereupon further comprising the step of muting between the item presently being played and the next item of live multimedia content.

11. The method of claim 1, wherein the determining step includes determining whether a start time of the next item of live multimedia content is earlier than an end time of the item being played in the playing step, whereupon further comprising the step of buffering the next item of live multimedia content, and wherein the playing step includes playing the buffered next item of multimedia content.

12. The method of claim 1, wherein the rotating step includes shuffling the playlist.

13. A method of playing audio content comprising the steps of:
defining a desired genre of audio content;
identifying both recorded and live audio content of that desired genre;
assembling the identified recorded audio content into a playlist;
playing an item from the playlist;
determining whether an item of live audio content of the desired genre is near a beginning of its being played by comparing a start time of the next item of live audio content to an end time of the item being played in the playing step and determining whether a difference between the start time and the end time is less than a predetermined time period;
rotating the playlist upon completion of playing the item from the playing step, wherein if an item of live audio content is found in the determining step rotating the live item to the next item to be played from the playlist; and
repeating the playing, determining and rotating steps.

14. The method of claim 13, wherein the determining step includes selecting only those items of live audio content that will not have started playing before the end time of the item being played in the playing step.

15. The method of claim 13, wherein the playing step includes establishing if the next item to be played in the playlist is an item of live audio content that has already passed its start time, wherein the playing step performs a fade between the item being played and that next item of live audio content.

16. The method of claim 13, wherein the determining step places a priority on found items of live audio content, wherein the playing step includes establishing if the next item to be played in the playlist has a priority wherein the playing step performs a fade-out of the item presently being played and a fade-in of that next item of live audio content.

17. The method of claim 13, wherein the determining step includes determining whether a start time of the next item of live audio content is earlier than an end time of the item being played in the playing step, whereupon further comprising the step of buffering the next item of live audio content, and wherein the playing step includes playing the buffered next item of audio content.

18. A receiver for receiving multimedia content comprising:
a media storage manager to recall recorded multimedia content;
a user interface coupled to the controller, the user interface for selecting and playing multimedia content, and defining a desired grouping of multimedia content; and
a controller coupled to the media storage manager, the controller identifies both recorded multimedia content on storage media and live multimedia content from the receiver of that desired grouping, the controller assembles the identified recorded multimedia content into a playlist for the user interface to play, the controller determines whether an item of live multimedia content of the desired grouping is near a beginning of its being played and rotates that item of live multimedia content to the next item to be played from the playlist.

19. The receiver of claim 18, wherein the desired grouping is based on genre.

20. The receiver of claim 18, wherein the desired grouping is based on artist.

21. The receiver of claim 18 wherein the desired grouping is based on one or more of a genre, artist, production studio, and creator.

22. The receiver of claim 18, wherein the controller compares a start time of the next item of live multimedia content from the receiver to an end time of the item presently being played by the user interface and determines whether a difference between the start time and the end time is less than a predetermined time period.

23. The receiver of claim 18, wherein the controller establishes if the next item to be played in the playlist is an item of live multimedia content that has already passed its start time, wherein the controller directs the user interface to perform fade between the item being played and that next item of live multimedia content.

24. The receiver of claim 18, wherein the controller places a priority on found items of live multimedia content and directs the user interface to fade between the item presently being played and the next item of live multimedia content.

25. The receiver of claim 18, wherein the controller determines whether a start time of the next item of live multimedia content from the receiver is earlier than an end time of the item presently being played by the user interface, whereupon controller directs the media storage manager unit to buffer the next item of live multimedia content for play by the user interface.

26. The receiver of claim 18, wherein said receiver comprises a wireless communication device in a vehicle.
